(19) United States
(12) Patent Application Publication
(10) Pub. No.: US 2011/0138631 A1
(43) Pub. Date: Jun. 16, 2011

(54) MULTIPURPOSE SHEARS

(76) Inventor: Christopher Smith, Suffolk, VA (US)

(21) Appl. No.: 13/029,537

(22) Filed: Feb. 17, 2011

Related U.S. Application Data
(63) Continuation-in-part of application No. 12/138,750, filed on Jun. 13, 2008.

(51) Int. Cl. B26B 13/22

(52) U.S. Cl. 30/146

(57) ABSTRACT

Multi-purpose trauma shears adapted to include structure that enables rapid and effective cutting suitable for use in combat situations, critical care acute medical use or medical traumas requiring the removal of outerwear in a rapid manner. A U-shaped housing is positioned on a loop grip of the shears, the housing having an insertion slot defining an opening at one end and at least one blade having a cutting edge mourned within the housing. The blades are positioned within the housing so as to present a cutting edge obliquely to the insertion slot, so as to rend material inserted into the insertion slot. The insertion slot is generally configured so that the operator may safely snip in one direction and rend in the reverse direction.

### CROSS-REFERENCE TO RELATED APPLICATION

This continuation-in-part application claims benefit of U.S. patent application Ser. No. 12/138,750, filed Jun. 13, 2008 and titled “MULTIPURPOSE SHEARS”, and U.S. Provisional Patent Application Ser. No. 60/937,220, filed on Jun. 26, 2007, and entitled “TRAUMA SHEARS”, the contents of which are hereby fully incorporated by reference.

### STATEMENT REGARDING GOVERNMENT SUPPORT

Not applicable

### BACKGROUND OF THE INVENTION

1. Field of the Invention

The present invention relates to shears serving multiple purposes. In particular, the present disclosure relates to shears having an edge tool suitable for use in combat situations, critical care acute medical use or medical traumas requiring the removal of outerwear in a rapid manner.

2. Description of the Related Art

Shears are a form of hand-held cutting tool, which are commonly used to cut material, paper, fabric, etc. The shears include a pair of crossing arms or blades that are pivotally mounted. One end of each arm has a shearing edge while the other end typically includes a loop shaped hand grip. The arms are mounted so that the shearing edges face each other inwardly. The pivot forms a fulcrum by which operation of the hand grips leverages the blades to shear the fabric or other materials.

Trauma shears are used to cut away a person's clothing to provide access for medical treatment. This tool is typically strong and durable, and is intended to shear through hems, pockets, layered fabric, straps, thick plackets, etc. Although specialization has led to refinement of a strong design capable of cutting a variety of tough materials, it has also limited the scope of applicability of such shears.

In some cases, for example, the speed of cutting may be more important than the strength of the shearing effect. The repetitive snipping involved in hand shearing can be time consuming. The blades of trauma shears and their strong design may not cut through certain sheet fabrics as quickly as required. The requirement for toughness in some shears may also lead to the use of durable but duller blades, which can be ineffective or inefficient when used to slice fabric. Further, the requirement that the blades of trauma shears be suitable for use adjacent to a person's skin when underneath clothing means that the blade ends are often short or limited beyond the pivot point. This limited length can further increase the time of cutting.

One approach to this problem has been for medical personnel to carry or store multiple types of shears, scissors, or knives. Trauma shears may be used for making an initial cut or cutting through seams and thick layers, while a different slicing or cutting tool might be used for cutting sheets of lighter material. Of course, time is lost while one tool is stored or set aside and the other tool is located and applied to the fabric. Some have attempted to solve such a problem by creating multi-function hand tools as may be seen in U.S. Pat. No. 6,698,049, which is somewhat configured like a modified pocket knife. Even with this approach, medical personnel must still pause from cutting in order to reconfigure the multi-function tool to access a different device.

Beyond a clear application for use in medical trauma or emergency services, as described above, it is contemplated that a device resolving these problems could have beneficial application for a variety of other activities, such as outdoor sports (e.g., fishing, hunting, climbing, skydiving, etc.), upholstery and other textile work, clothing assembly, crafts, etc.

Thus, it would be desirable to have a multi-purpose shear that is capable of quickly slicing sheet fabric as well as snipping through tough fabric. Of course, such a design should be safe and carry a low risk of cutting the user or any possible patient.

### SUMMARY OF THE INVENTION

The present disclosure describes a pair of multi-purpose trauma shears that include structure that enables rapid and effective cutting, shearing and rending of woven fabric.

An embodiment of the multi-purpose trauma shears of the present invention has a first elongated member with a distal shearing end and proximal gripping end, wherein the shearing end has a downwardly facing shearing edge and the gripping end defines a first loop adapted to receive one or more fingers and a second elongated member with a distal shearing end and a proximal gripping end, wherein the shearing end has an upwardly facing shearing edge and the gripping end defines a second loop adapted to receive a thumb. A pivot located between fire shearing end and the gripping end of the first member connects the first member to the second member, at a corresponding point between the shearing end and the gripping end of the second member, in an adjacent, complementary, and crossing manner, so that the shearing end of the first member is capable of pivoting higher than, the shearing end of the second member, the gripping end of the first member is lower than the gripping end of the second member. The shearing edge of the first member is thus adjacent and opposing to the shearing edge of the second member. Opening the gripping ends relative to each other opens the shearing ends away from each other in an opposing manner and closing the gripping ends relative to each other closes the shearing ends in an adjacent manner. Optionally, the first and second members may be angled obtusely at a corresponding point near the pivot to enable operation of the shears while the second member is proximate to a flat surface where the angle is from about 170 degrees to about 140 degrees,

A U-shaped housing is positioned on the first or second loop. The U-shaped housing defines an insertion slot having an opening at one end and has at least one blade having a cutting edge mounted within the housing, with the blade positioned within the housing so as to present the cutting edge obliquely to the insertion slot to cut material inserted into the insertion slot. Thus, the U-shaped housing may be positioned on the first or second loop at a desired orientation to that loop. The housing may be positioned relative to that loop so as to orient the insertion slot substantially tangential to that loop. Alternatively, the housing may be positioned relative to that loop so as to orient the insertion slot at an angle ranging from parallel with the shearing ends with the opening facing in the distal direction to perpendicular with the first gripping end with the opening facing downwardly.

In a different embodiment, the housing may be positioned relative to that loop so as to orient the insertion slot at an angle ranging from parallel with the shearing ends with the opening facing in the proximal direction to perpendicular with the gripping end with the opening facing upwardly.

In another embodiment the U-shaped housing may be constructed or coated with luminescent or fluorescent treatments that are more visible in low light settings. Luminescent treatments may include, but are not limited to, paints, coatings, adhesive strips, tapes, markers or pigments, such as, but not limited to GCX 111289 GITD supplied by RTP. Co.

In another embodiment, the shearing end of the second member further comprises a clothes lifter at its distal tip. Optionally, the clothes lifter at the distal tip may further include a recessed band cutting edge.

The U-shaped housing is integrated fully onto the loop on which it is positioned, or at least a portion is on that loop. Optionally, the at least one blade may be removably mounted within the housing with the U-shaped housing positioned on the first or second loop.

In another embodiment, the U-shaped housing may be integrated onto the first or second loop and the U-shaped housing and that the loop and U-shaped housing are portionally longitudinally split into at least two pieces defining a loop section and a detachable section, further comprising at least one housing fastener configured to fasten the two pieces of the U-shaped housing together in a detachable manner, and at least one member fastener configured to detachably fasten, the two pieces of the first loop together and to the elongated member. In an alternate embodiment, the U-shaped housing may be longitudinally split into two pieces, and further include at least one housing fastener configured to fasten the two pieces together in a detachable manner, and the U-shaped housing may be adapted to surround, a portion of the first or second loop so that the housing may be positioned detachable on that loop.

In another embodiment, the U-shaped housing may be longitudinally split into two pieces and have at least one housing fastener configured to fasten the two pieces together in a detachable manner, the U-shaped housing being adapted to surround a portion of the first or second loop so that the housing may be positioned detachably on that loop, and wherein the at least one blade may be removably mounted, within the housing and the housing is configured so as to define a compartment for storage of blades when the two nieces are fastened together. In a further embodiment, the first or second loop may have receiving structure defining a receiving surfaces and the U shaped housing may have connecting surfaces adapted to detachably mate with the receiving surfaces so that the housing may be positioned detachably on the first or second loop. In a further embodiment, the multi-purpose shears of the present invention may have a first elongated member with a distal shearing end and proximal gripping end, wherein the shearing end has a downwardly facing shearing edge and the gripping end defines a first loop adapted to receive one or more fingers and a second elongated member with a distal shearing end and a proximal gripping end, wherein the shearing end has an upwardly facing shearing edge and the gripping end defines a second loop adapted to receive a thumb. A pivot located between the shearing end and the gripping end of the first member connects the first member to the second member, at a corresponding point between the shearing end and the gripping end of the second member, in an adjacent, complementary, and crossing manner so that the shearing end of the first member is capable of pivoting higher than, the shearing end of the second member, the gripping end of the first member is lower than the gripping end of the second member, the shearing edge of the first member is adjacent and opposing the shearing edge of the second member. Opening the gripping ends relative to each other opens the shearing ends away from each other in an opposing manner and closing the gripping ends relative to each other closes the shearing ends in an adjacent manner. A U-shaped housing is positioned on the first or second loop. The U-shape housing defines an insertion slot having an opening at one end and at least one blade having a cutting edge removably mounted within the housing. The blade is positioned within the housing so as to present the cutting edge obliquely to the insertion slot to cut material inserted into the insertion slot. The U-shaped housing may be longitudinally split into two pieces, further comprising at least one housing fastener configured to fasten the two pieces together in a detachable manner, with the U-shaped housing being adapted to surround a portion of the first or second loop so that the housing may be positioned detachably on the that loop. Optionally, the housing may be configured further to define a compartment for storage of blades when the two pieces are fastened together. The housing may be positioned on the first or second loop with the insertion slot relative to that loop so as to orient the insertion slot substantially tangentially to the loop.

In another embodiment the first and second loops are larger than the seventy-fifth percentile of hands to allow for use by a user wearing gloves where the opening for placement of the fingers is about 2.5 inches to about 5 inches in length and about 1.25 inches In width to about 2.5 inches and the opening for the thumb is from about 1.25 inches in diameter to about 2.5 inches in diameter and both loops have a radiused inner surface.

In another embodiment the U-shaped housing is positioned facing the user to allow for the user to pull the multi-purpose shears toward the user thereby ergonomically reducing the strength required to rend fabric, seams and sewn features such as straps and also to draw the fabric away from the skin surface of the patient providing additional protection from trauma. Orientation of the U-shaped member may be orientated about the longitudinal axis of the proximal gripping end of an elongate member as preferred by the user from about 0 degrees +/−45 degrees. Rotation of the U-shaped, member aids in reducing the effort by the user to remove fabric from a patient and also for comfort when carrying the shears in a thigh pocket. The U-shaped housing may also be reversible with the U-shaped housing facing forward or to the side

In another embodiment there are one or more blades that have a straight or continuous edge or a serrated edge at an oblique angle to the U-shaped housing opening reducing the contact angle with a fabric and reducing the amount of force required, by the user to rend the fabric.

In another embodiment there are one or more blades substantially embedded in an acute angle within the U-shaped housing opening of about 10 mm or less thereby providing a measure of safety by preventing accidental contact with any human appendages.

In another embodiment the first elongate member and/or the second elongate member shearing edge is a serrated or discontinuous edge to aid in rending fabric and may be of stainless steel, high carbon steel, ceramic, titanium or other composite material or coating,

In another embodiment the U-shaped housing opening is radiused on the outer and inner surfaces to prevent impaling of patients or users when used in a rending action.

In another embodiment the rending of fabric by the U-shaped housing or the shearing edges may produce rough or inconsistent edges on the fabric.

In another embodiment the U-shaped housing is shaped to provide a percussive surface substantially opposite the opening of the insertion slot for testing hypo or hyper resonance of the abdominal or chest cavities or for neurological testing as a reflex hammer when used in conjunction with the user grasping the scissors unit in a closed position, positioning a finger on the lifting lip of the blade and pivotably moving the handle and U-shaped housing in a lateral motion such that the U-shaped housing strikes the area to be percussed and/or the deep tendon area. The percussive surface being about 6 mm to about 10 mm thick and may be a desired softer material and/or shaped with a blunt angular point as a neurological tool.

In another embodiment the blades within the U-shaped member are individually replaceable or may be replaced as a single unit,

In another embodiment the U-shaped member is a kit adaptable to be secured to a gripping surface of a pair of shears.

In another embodiment the U-shaped housing has at least two blades where each blade edge is at an oblique angle to the insertion slot and facing each other.

In another embodiment the second loop may contain a pivotable or hinged section that opens inwardly or outwardly or to the side of the loop and is able to be releasably fastened to a stationary portion of the second loop. This would provide access to the second loop to be used to surround a rope, belt loop, cable, hook or other feature for securing or carrying to or on a user.

In another embodiment the first loop may contain a pivotable or hinged section for pivoting one end of the U-shaped housing laterally away from the stationary portion of the second loop. The other end of the pivoting section would be releasably fastened to the stationary portion of the second loop. This would provide access to the second loop to be used to surround a rope, belt loop, cable, hook or other feature for securing or carrying to or on a user. In another embodiment the multi-purpose trauma shears have a first elongated member with a radiused distal shearing end. The radius is about the height of the first elongated member and a proximal gripping end, where the shearing end has a downwardly facing shearing edge. The gripping end defines a first loop adapted to receive one or more fingers. There is a second elongated member with a distal shearing end and a proximal gripping end. The shearing end has a blunt distal tip and an upwardly facing shearing edge and a downwardly facing back edge and defines a blunt recess proximal to the distal tip that extends beyond the downwardly facing shearing edge. There is a lift lip perpendicular and substantially adjacent to the second elongated member on the back edge. The gripping end defines a second loop adapted to receive a thumb. There is a pivot located between the shearing end and the gripping end of the first member connecting the first member to the second member at a corresponding point between the shearing end and the gripping end of the second member in an adjacent, complementary, and crossing manner so that the shearing end of the first member is capable of pivoting higher than the shearing end of the second member. The gripping end of the first member is lower than the gripping end of the second member. The shearing edge of the first member is adjacent and opposing the shearing edge of the second member where, when a user opens the gripping ends relative to each other, opens the shearing ends away from each other in an opposing manner and closing the gripping ends relative to each other closes the shearing ends in an adjacent manner. The first and second elongate members are angled obtusely at a corresponding point near the pivot. Additionally there is a U-shaped housing having a surface defining an insertion slot with an opening at one end and at least one blade having a shearing edge recessed from the surface of the U-shaped housing and mounted within the U-shaped housing. The blade positioned within the U-shaped housing presents the shearing edge obliquely to the insertion slot to rend a patient's clothing material inserted into the insertion slot. There is a percussive surface on an outer radius substantially opposite the insertion slot and the U-shaped housing is positioned on the first loop with the insertion slot at a desired orientation to the first loop. The U-shaped housing may be positioned on the second loop as well with the insertion slot at a desired orientation to the second loop.

In another embodiment the multi-purpose trauma shear may be a kit having a first elongated member with a radiused distal shearing end. The radius is about the height of the first elongated member and a proximal gripping end, where the shearing end has a downwardly facing shearing edge. The gripping end defines a first loop adapted to receive one or more fingers. There is a second elongated member with a distal shearing end and a proximal gripping end. The shearing end has a blunt distal tip and an upwardly facing shearing edge and defines a blunt recess proximal to the distal tip that extends beyond the downwardly facing shearing edge and a downwardly facing back edge. There is a lift lip perpendicular and substantially adjacent to the second elongated member on the back edge. The gripping end defines a second loop adapted to receive a thumb. There is a pivot located between the shearing end and the gripping end of the first member connecting the first member to the second member at a corresponding point between the shearing end and the gripping end of the second member in an adjacent, complementary, and crossing manner so that the shearing end of the first member is capable of pivoting higher than the shearing end of the second member. The gripping end of the first member is lower than the gripping end of the second member. The shearing edge of the first member is adjacent and opposing the shearing edge of the second member where, when a user opens the gripping ends relative to each other, opens the shearing ends away from each other in an opposing manner and closing the gripping ends relative to each other closes the shearing ends in an adjacent manner. The first and second elongate members are angled obtusely at a corresponding point near the pivot. Additionally there is a U-shaped housing having a surface defining an insertion slot having an opening at one end and at least one blade having a shearing edge recessed from the surface of the U-shaped housing and removably mounted within the U-shaped housing. The blade is positioned within the U-shaped housing so as to present the shearing edge obliquely to the insertion slot to rend material inserted into the insertion slot. The U-shaped housing may be longitudinally split into two pieces, further comprising at least one housing fastener configured to fasten the two pieces together in a detachable manner. The U-shaped housing may be adapted to surround a portion of the first loop or second loop forming a percussive surface on an outer radius substantially opposite the insertion slot. The U-shaped housing being positioned detachably on the first loop or second loop, the U-shaped, housing configured further to define a compartment for storage of blades. The U-shaped housing may be positioned on the first loop or second loop with the insertion slot relative to the first loop or second loop so as to orient the insertion slot substantially tangentially to the first loop or second loop and the two pieces are fastened together in a clamping fashion around the first loop or the second loop.

### DESCRIPTION OF THE DRAWINGS

FIG. 1a is a side view of an embodiment of the present invention.

FIG. 1b is a detail of an end view of the first loop and U-shaped member.

FIGS. 2a and 2b depict embodiments of the present invention.

FIG. 3 depicts embodiments of the present invention.

FIG. 4 depicts an embodiment of the present invention.

FIG. 5 depicts an embodiment of the present invention with a detachably mounted housing.

FIG. 6 depicts an embodiment of the present invention with a detachably mounted housing.

FIG. 7a depicts an embodiment of the present invention with a detachably mounted housing; FIG. 7b depicts a proximal view of the housing.

FIG. 8a depicts a side view of an embodiment of the present invention and

FIG. 8b is a detail of that embodiment.

FIG. 9 is an isometric embodiment of the U-shaped housing.

FIG. 10a is a view of a pivotable U-shaped housing.

FIG. 10b is a view of the pivoted U-shape housing.

FIG. 11a is a view second loop with an inwardly pivotable loop section.

FIG. 11b is an end view of a partial overmolded loop and detachable U-shape housing.

### DETAILED DESCRIPTION

The present invention is a pair of multi-purpose trauma shears that have the additional structure to enable a rapid, safe, and effective rending of both sheet fabric and tough or layered fabric. By definition the rending of a fabric is, “to tear or be torn violently” (Wordnetweb/Princeton.edu). “To separate into parts with force or sudden violence; to tear asunder” (1913 Webster/www.Dictionary,net). Clearly rending is without regards to measurements, lines and secondary operations, such as sewing or rejoining the pieces of fabric.

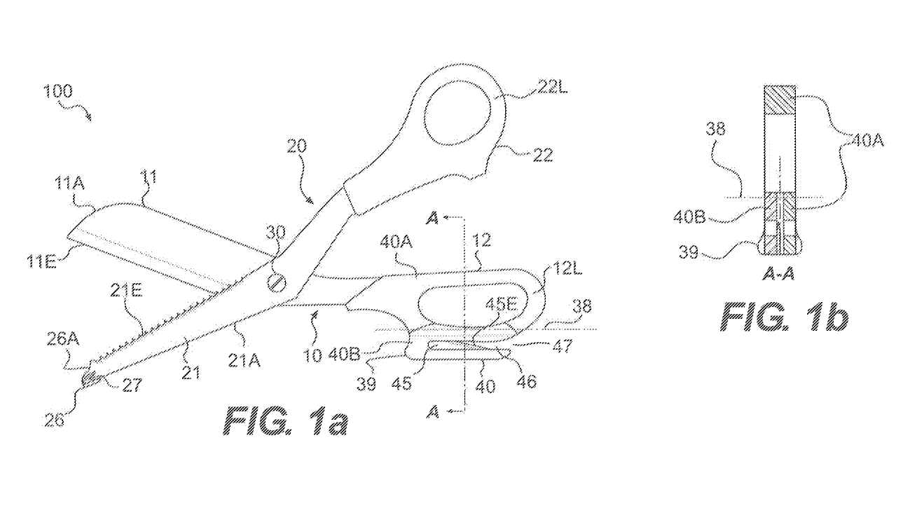

In reference to FIGS. 1a-8, shears 100 may be viewed as having a first elongated member 10 or blade and second elongated member 20 or blade. First member 10 includes a first shearing end 11 and first gripping end 12 or handle, while second member includes corresponding second shearing end 21 and second gripping end 22 or handle.

With initial reference to FIG. 1a, for the purposes of this description, the term “distal” or distally refers generally to a direction away or more distant from a user of the shears 100, while the term “proximal” or proximally refers to a direction toward or more near to a user of the shears 100, when a user is cutting rending fabric. Thus, the first elongated member 10 with a distal first shearing end 11 and proximal first gripping end 12, may be distinguished by a first shearing end 11 having a downwardly facing shearing edge 11E: its first gripping end 12 defines a first loop 12L adapted to receive one or more fingers. The first shearing edge 11 has a radius about the height of the first elongated member 10 at the first shearing edge 11, where if the height of the elongated member 10 is about 15 mm then the radius is about 15 mm. Similarly, in asymmetric fashion, second elongated member 20 with a distal second shearing end 21 and a proximal second gripping end 22, may be distinguished by a second, shearing end 21 having an upwardly facing shearing edge 21E; its second gripping end 22 defines a second loop 22L adapted to receive a thumb. The distal second elongated member 21 also includes a lift lip 26 perpendicular and substantially adjacent to the second elongated member 21 on a back edge 21b the lift lip 26 may have a band cutter edge 27 that is recessed. Shearing edge 11E and/or 21E may have an edge that is either continuous or discontinuous, such as a serrated edge. This configuration supports right handed use; the shears 100 of the present invention should be construed as extended to configurations supporting left handed use as well.

Elongated members 10, 20 are mounted together at pivot 30 to shear or snip fabric. Thus, this pivot 30 is located between the first shearing end 11 and the first gripping end 12 of the first member 10, and connects the first member 10 to the second member 20 at a corresponding point between the second shearing end 21 and the second gripping end 22 of the second member 20. Thus, for this embodiment the elongated members 10, 20 are pivotally mounted in an adjacent, complementary, and crossing manner so that the first shearing end 11 of first elongated member 10 is capable of pivoting higher than the second shearing end 21 of the second elongated member 20. Conversely, the first gripping end 12 of the first elongated member 10 is lower than the second gripping end 22 of the second elongated member 20. The shearing edge 11E of the first elongated member 10 is adjacent and opposing the shearing edge 21E of second elongated member 20, In this way, opening the gripping ends 12, 22 relative to each, other opens the shearing ends 11, 21 away from each other in an opposing manner and closing the gripping ends 12, 22 relative to each other closes the shearing ends 11,21 in an adjacent manner.

For this embodiment, first elongated member 10 may be considered as an upper member, for convention of reference, to the extent that its first shearing end 11 pivots within an upper relative area; conversely, second elongated, member 20 may be considered a lower member as its second shearing end 21 pivots within a lower relative area. However, the present invention should be construed as also encompassing embodiments in which first and second members 10, 20 may rest substantially adjacent to each other when trauma shears are in a fully closed position. Gripping end 12 and gripping end 22 may contact each other in the closed position. Gripping end 12 and 22 may be constructed of a tilled polymer, more specifically a polymer of, but not limited to, polycarbonate, ABS or polypropylene with a fiberglass filler (GF) of 0-15 percent.

The elongated first and second elongated, members 10, 20 may preferably, though not necessarily, be angled obtusely at corresponding points near the pivot 30 to enable operation, of the shears 100 while the second elongated member 20 is proximate to a flat surface, such as a table or the skin of a patient (not shown) for embodiments of shears 100 used as trauma shears. In other words, this allows operation of the shears 100 with the second shearing end 21 of the second elongated member 20 held proximate or against the surface; the second shearing end 21 of lower second elongated member 20 may be slid underneath fabric or clothing while the upper first elongated member 10 is cycled to shear or snip the material or clothing. The second shearing end 21 also has a lift lip 26 that operates in conjunction with the blunt tip 26a that curves upward to lift the clothing to minimize impaling of a patient. Thus, in some types of operation, the elongated members 10, 20 form a mouth that can open and close by motion of the upper first elongated member 10 relative to second elongated member 20. An effective angle for embodiments of shears 100 as trauma shears is 150 degrees. However, a wide variety of obtuse angles may be used, taking into consideration the application, desired leverage, wrist angle, freedom of movement relative to any surface, and freedom of operation,

With reference to FIG. 1a, optionally the second shearing end 21 of the lower second elongated member 20 may have a blunt tip, and also optionally may include a lift lip 26 that can be used to lift material or clothing into the mouth of the shears 100 formed by the distal shearing ends 11, 21, For embodiments of shears 100 used in trauma, bluntness may prevent inadvertent scratching or puncturing of a patient. The lift lip 26 may optionally include a recessed cutting edge 27 that may be used in a pulling fashion to remove or cut strings, threads, or thin hospital-type identification bands.

As may be seen in FIG. 1a, one or both of the distal shearing ends 11, 21 may be serrated to improve the grip on material or cloth during snipping. Given the value of such shears 100 during trauma or medical response, preferably such embodiments of shears 100 may be manufactured from durable and high quality materials, such as stainless steel, high carbon steel, ceramic, titanium or other composite material or coating at least for the distal shearing ends 11, 21.

As noted above, the shears 100 of the present invention may be adapted for use with, either the right or the left hand, as may be desired. Such adaptation from a right hand to the left generally involves a shift of asymmetric features to accommodate the thumb and fingers of the left hand.

Another aspect is a generally U-shaped housing 40 positioned on one of gripping ends 12, 22, at the point taming loops 12L or 22L. FIGS. 1a-11b depicts a variety of embodiments. With reference to FIG. 1a, U-shaped housing 40 defines an insertion slot 46 defining an opening 47 at one end and at least one blade 45 having a cutting edge 45E mounted, within U-shaped housing 40. The at least one blade 45 is positioned within the U-shaped housing 40 so as to present a cutting edge 45E obliquely to the insertion slot 46, so as to cut or slice material inserted into the insertion slot 46. The insertion slot 46 is generally configured in a direction that permits ergonomic handling of the shears 100 for both snipping (i.e., using distal shearing ends 11, 21) and for rending of fabric (i.e., using blade 45). For example, one embodiment of the shears 100 presents opening 47 facing in the proximal direction, relative to the first and second elongated members 10, 20, so that an operator may snip in one direction and rend in the reverse direction. Thus, the insertion slot 46 can be oriented substantially tangentially to the longitudinal axis 38 of loops 12L or 22L, as applicable. The U-shaped member 40 is shaped to provide a percussive surface 39 substantially opposite the opening of the insertion slot 47 for testing hypo or hyper resonance of the abdominal or chest cavities or for neurological testing as a reflex hammer when used in conjunction with the user grasping the shears 100 in a closed position, positioning a finger on the lifting lip 26 of the elongate members 21, 11 and pivotably moving the loops 22L, 12L and U-shaped housing 40 in a lateral motion such that the U-shaped housing 40 percussive surface 39 strikes the area to be percussed and/or the deep tendon area. The percussive surface 39 is about 6 mm to about 10 mm thick.

The U-shaped housing 40 may be positioned relative to a respective one of the gripping ends 12, 22. so as to orient the insertion slot 46 at an angle ranging anywhere from parallel with the mounting gripping end 12 or 22, with the opening 47 facing in the distal direction, to perpendicular with the mounting gripping end 12 or 22 with the opening 47 facing downwardly. Preferably, though not necessarily, for embodiments of shears 100 used as trauma shears, U-shaped housing 40 is mounted on first gripping end 12 and may be rotated around the longitudinal axis 38 of loop 12L at a desired rotational position from about 0 degrees +/−45 degrees. In another example, the U-shaped housing 40 may be positioned relative to the mounting gripping end 12 or 22 so as to orient the insertion slot 46 at an angle ranging from parallel with the shearing ends 11 or 21 with the opening 47 racing in the proximal direction to perpendicular with the mounting gripping end 12 or 22 with the opening 47 facing upwardly. FIG. 1a depicts shears 100 with U-shaped housing 40 mounted on first gripping end 12 at first loop 12L, with opening 47 facing proximally and. insertion slot 46 somewhat parallel to first gripping end 12. For embodiments of shears 100 used as trauma shears, the Applicant has discovered this configuration to be effective, easy to use, and quick to operate. Shears 100 may also include either gripping members 12L and 22L including the U-shaped member 40 and at least one blade 45 molded as a continuous, single piece construction.

FIG. 1b is an end view of the U-shaped housing 40 showing a longitudinal split that defines a loop section 40A and a detachable section 40B. Loop section 40A is an integral part of grip 12, 22. Detachable section 40B allows for access to the blade(s) 45 for replacement. Also shown is a widened percussive surface 39. Detachable section 40B when properly oriented is removeabiy secured to loop section 40A by one or more fasteners.

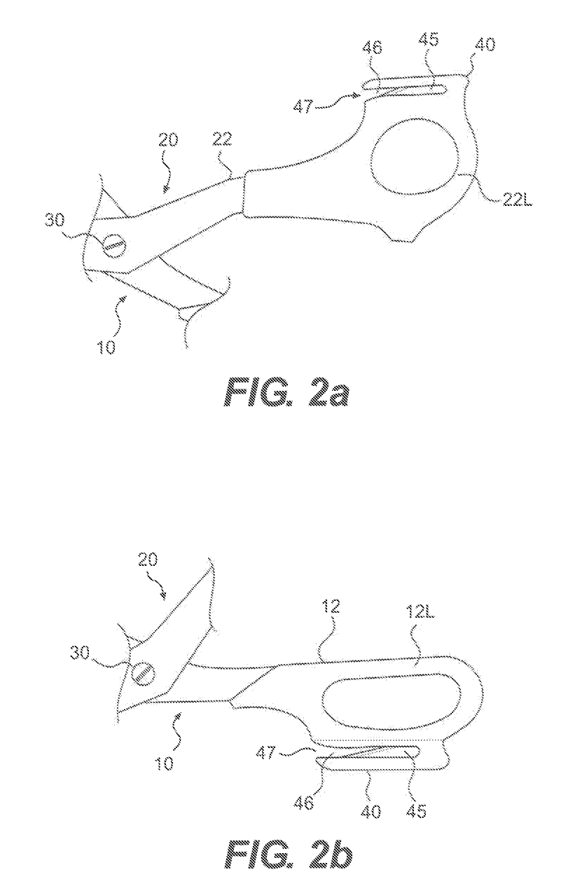

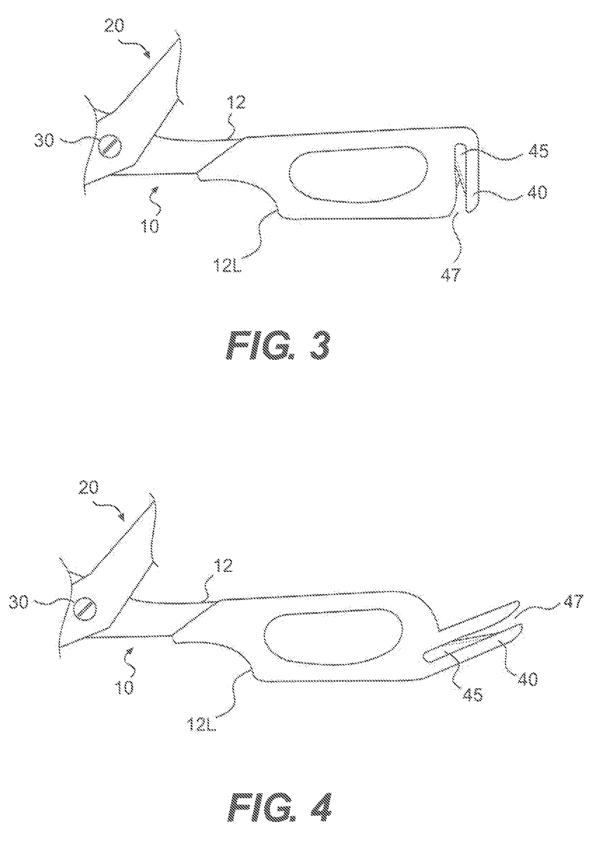

FIGS. 2a and 2b depict shears 100 with the orientation of U-shaped housing 40 reversed so that opening 47 faces distally. In FIG. 2a, U-shaped housing 40 is positioned on second loop 22L of elongated member 20. FIG. 2b depicts U-shaped housing 40 positioned on first loop 12L of elongated member 10. FIG. 3 depicts shears 100 with a different orientation such that opening 47 facing downwardly which, similarly, could be reversed such that opening 47 would face upwardly (not shown). Optionally, as also shown in FIG. 3, is an embodiment of shears 100 in which positioned within U-shaped housing 40 is at least one blade 45 comprising two blades 45. Such an embodiment provides enhanced cutting or slicing effect. FIG. 4 depicts an embodiment of shears 100 in which U-shaped housing 40 is mounted on first gripping end 12 in a manner so that insertion slot 46 is somewhat parallel to first gripping end 12, but configured differently from the embodiment of FIG. 1.

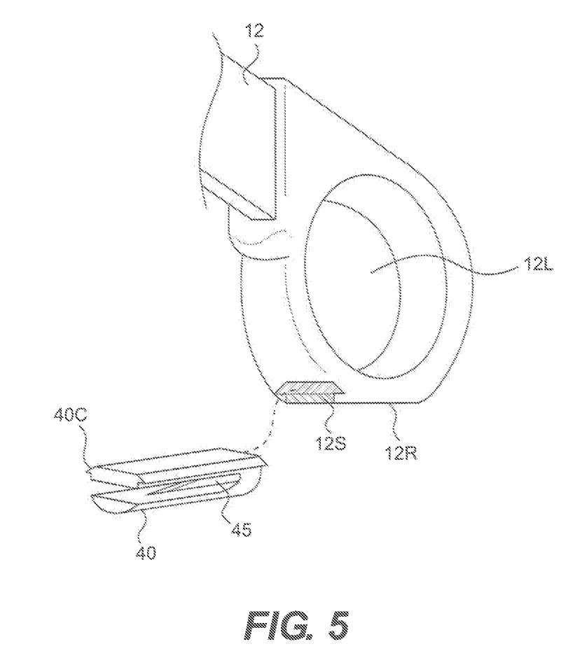

Previous figures nave shown U-shaped housing 40 integrated into one of first and second loop 12L or 22L. Optionally, as shown, in FIG. 5, the U-shaped housing 40 may be mounted detachably or removably on one of mounting gripping ends 12 or 22 to enable removal of the U-shaped housing 40; in some embodiments, this may enable replacement of the at least one blade 45 positioned within the U-shaped housing 40, or complete replacement of U-shaped housing 40. In this embodiment, shears 100 are shown with first gripping end 12 having receiving structure 12R. with outwardly directed receiving surfaces 12S and replaceable U-shaped housing 40 having projecting connecting surfaces 40C that detachably mate with receiving surfaces 12S of receiving structure 12R. Conversely, receiving structure 12R might have inwardly projecting surfaces 12S (not shown) and U-shaped housing 40 might have inwardly directed connecting surfaces 40C for mating.

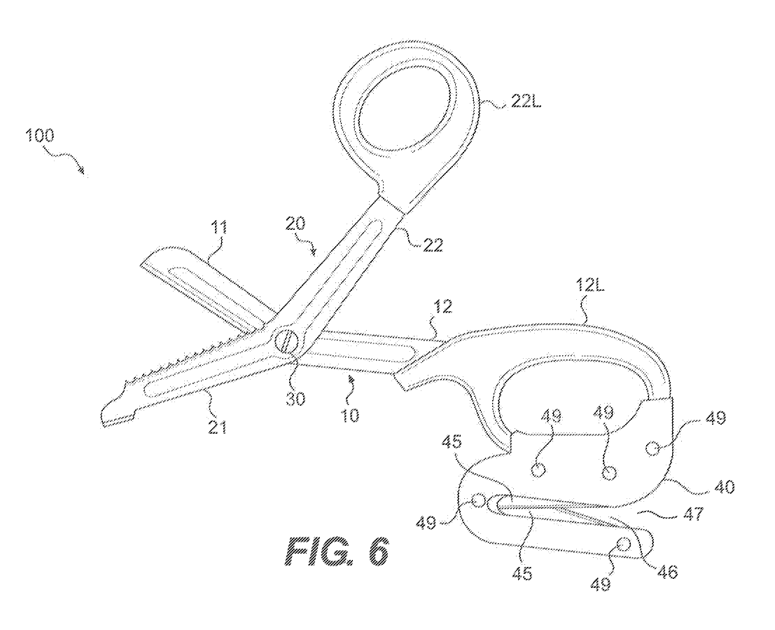

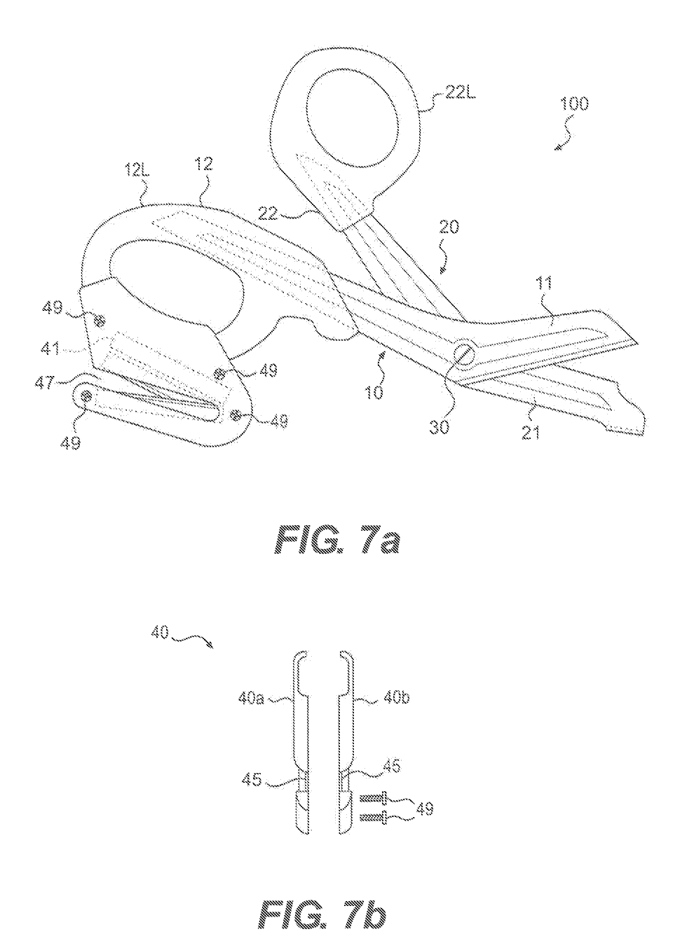

Other detachable structures may be appropriate for other embodiments of shears 100. For example, shears 100 shown in FIGS. 6 and 7a employ housing fasteners 49 for mounting a longitudinally split U-shaped housing 40 (i.e., split into two pieces such as loop section 40A and detachable section 40B as shown in the proximal, view of FIG. 7b) onto first loop 12L of first gripping end 12. In this ease, U-shaped housing 40 may be adapted to surround a portion of the first loop 12L. Optionally, such a longitudinally split configuration of U-shaped. housing 40 enables the definition of storage compartment 41. within U-shaped housing 40, which may be accessed, by removal of housing fasteners 49. Optionally, blades 45 may be removably positioned within U-shaped housing 40, and. such storage could be used to store replacement blades 45, Another aspect of the present Invention is directed to a retrofit longitudinally split U-shaped housing 40 containing at least one blade 45, which may be detachably positioned parallel to the loop 12 or rotated about +/−45 degrees (not shown) around the longitudinal axis of loop 12 or mounted onto one of loops 12L or 22L of conventional shears to norm shears 100, as shown in FIG. 6.

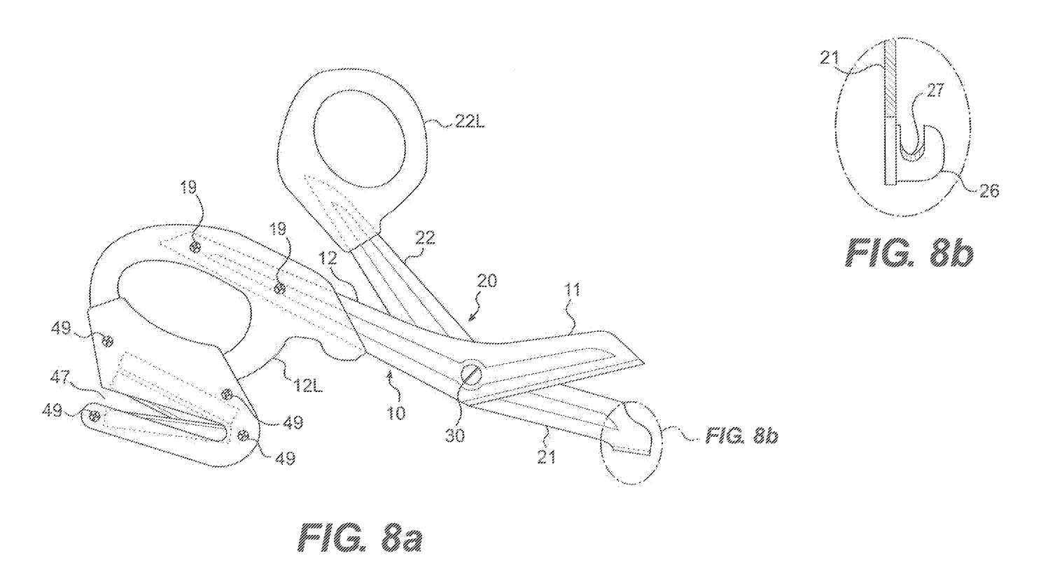

FIG. 8 shows an alternative embodiment in which U-shaped housing 40 is integrated into first bop 12L, but that such first loop 12L is similarly longitudinally split, i.e., into two pieces (not shown), and may be fastened to or removed from corresponding first gripping end 12 of elongated member 10 by member fasteners 19, With first loop 12L, longitudinally split, U-shaped housing 40 is also longitudinally split, so that removal of member fasteners 19 and housing fasteners 49 enables removal of first loop 12L from first gripping end 12 of elongated member 10, and separation of the pieces (not shown) of first loop 12L. Similarly, such a configuration may be adapted for use with, second loop 22L and second gripping end 22.

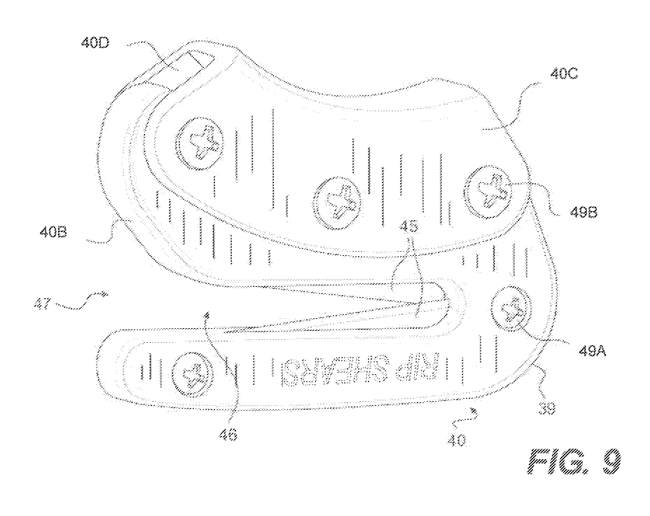

FIG. 9 is an isometric of an embodiment of the U-shaped housing 40. The U-shaped housing may be constructed of a filled polymer, more specifically a polymer of but not limited to, polycarbonate, ABS or polypropylene with a fiberglass filler (GF) of 0-15 percent and may be pigmented or colored, with a fluorescent or low light pigment or coloring technique. Shown is the U-shaped housing 40 with an opening 47 for the insertion slot 46. Within the insertion slot are at least one blade 45 (two shown). The blade(s) 45 are loop section 40A and detachable section 40B where the detachable section 40B is separable in a similar manner as from the loop section 40A. When loop section 40A and detachable section 40B are fastened together by the bottom fastener(s) 49, the percussive surface 39 is at a desired thickness. The U-shaped member 40 is then placed against the outside of loop 12L or 22L. (not shown) where U-clip 40C is placed, from the inner loop 12L, 22L over and surrounding the loop 12L, 22L, surface and over the U-shaped housing 40 until the top fastener(s) 49 secure the U-clip 40C and encapsulate the loop 12L, 22L in channel 40D. In this manner multi trauma shears 100 may be formed by U-shaped housing 40 fastened to U-clip 40C such that loop 12L or 22L is releasably captured or encapsulated within the U-shaped housing 40 and U-clip 40C.

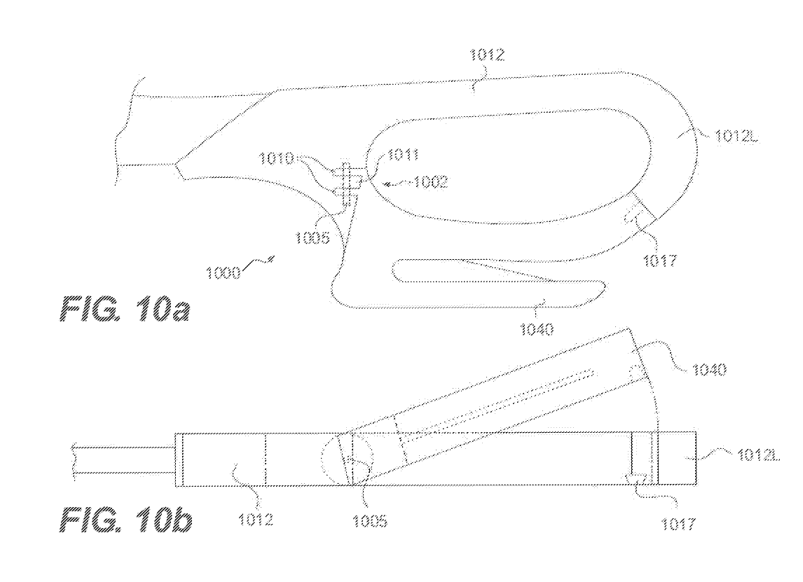

FIG. 10a shows another embodiment as a pivotable U-shaped housing 1040. The pivotable U-shaped housing 1040 is pivotably connected to the pivotable first gripping end 1012 at a distal point on pivotable first loop 1012L, The pivot assembly 1002 is shown using a hinge pin 1005 and a series of hinge ears 1010 where the hinge ears interleaf with a hinge ear 1011 that is integral with the first gripping end 1012, A releasable latch 1017 secures the pivotable U-shaped housing 1040 at the proximal end of the pivotable first loop 1012L enclosing the pivotable first loop 1012L. FIG. 10b shows the pivotable U-shaped housing 1040 released in a lateral direction to the first gripping end 1012 opening pivotable first loop 1012L. Lateral release of the latch 1017 of the pivotable U-shaped housing 1040 provides access to the Inner portion of pivotable first loop 1012L for removeably securing the pivotable multipurpose trauma shears 1000 on a loop, belt, rope, cable or hook or other object without limiting the available area within the pivotable first loop 1012L or compromising the functionality of the pivotable U-shaped housing 1040 for rending fabric,

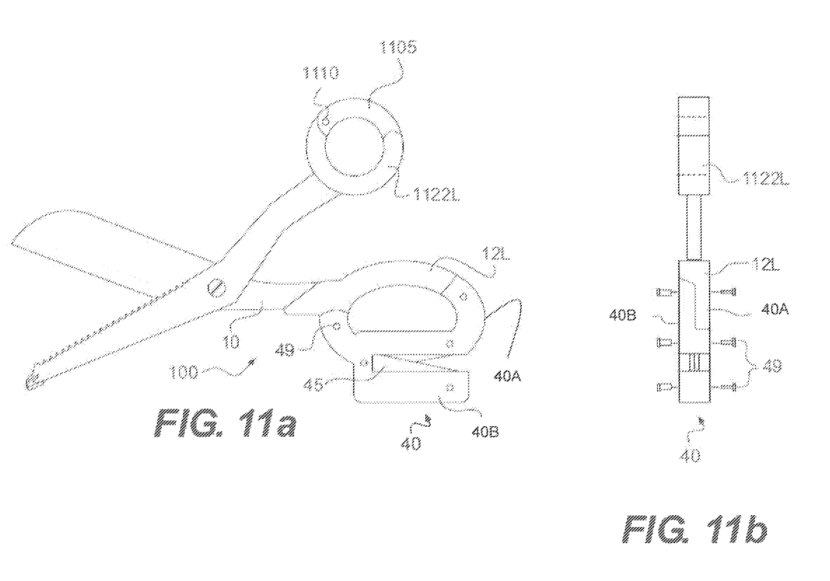

FIG. 11a shows an embodiment for a second loop 1122L with a perpendicular or lateral inwardly or outwardly pivotable loop section 1105, Hinge assembly 1110 may be attached at a distal point or a proximal point on the pivotable second loop 1122L and allows for rotation in either lateral direction from the second loop 1012L. Multipurpose trauma shears 100 may also include the first gripping end 12L as a separate construction attached to the first elongate member 10 including a loop section 40A which is shown in FIG. 11b as including a portion of the U-shaped member 40 and a substantial portion of first loop 12L. Detachable section 40B is removeably secured to loop section 40A and contains at least one blade 45 and is molded as a continuous, single piece detachable construction.

FIG. 11b is an end view of the U-shaped housing 40 showing a longitudinal split that defines a loop section 40A and a detachable section 40B. Loop section 40A is an integral part of first loop 12L. Detachable section 40B allows for access to the blade(s) 45 for replacement. Detachable section 40B when properly oriented is removeably secured to loop section 40A by one or more fasteners 49.

The above examples should be considered to be exemplary embodiments, and are in no way limiting of the present invention. Thus, while the description above refers to particular embodiments, it will be understood that many modifications may be made without departing from the spirit thereof.

What is claimed is:

1. Multi-purpose trauma shears, comprising:
a first elongated member with a radiused distal shearing end where the radius is about the height of the first elongated member and a proximal gripping end, wherein the shearing end has a downwardly facing shearing edge and the gripping end defines a first loop adapted to receive one or more fingers;
a second elongated member with a distal shearing end and a proximal gripping end, wherein the shearing end has a blunt distal tip and an upwardly facing shearing edge and a downwardly facing back edge, the distal shearing end defines a blunt recess proximal to the distal tip that extends beyond the downwardly facing shearing edge and a lift lip perpendicular and substantially adjacent to the second elongated member on the back edge and the gripping end defines a second loop adapted to receive a user's thumb;
a pivot located between the shearing end and the gripping end of the first member connecting the first member to the second member, at a corresponding point between the shearing end and the gripping end of the second member, in an adjacent, complementary, and. crossing manner so that the shearing end of the first member is capable of pivoting higher than the shearing end of the second member, the gripping end of the first member is lower than the gripping end of the second member, the shearing edge of the first member is adjacent and opposing the shearing edge of the second member, wherein opening the gripping ends relative to each other opens the shearing ends away from each other in an opposing manner and closing the gripping ends relative to each other closes the shearing ends in an adjacent manner;
the first and second elongate members angled obtusely at a corresponding point near the pivot;
a U-shaped housing having a surface defining an insertion slot having an opening at one end and at least one blade having a shearing edge recessed from the surface of the U-shaped housing and mounted within the U-shaped housing, the blade positioned within the U-shaped housing so as to present the shearing edge obliquely to the insertion slot to rend a patient's clothing material inserted into the insertion slot, a percussive surface on an outer radius substantially opposite the insertion slot; and
wherein the U-shaped housing is positioned on the first loop with the insertion slot at a desired orientation to the first loop.

2. The multi-purpose trauma shears according to claim 1, wherein the first and second elongate member distal shearing edges are serrated providing a discontinuous edge.

3. The multi-purpose trauma shears according to claim 1, wherein the U-shaped housing is positioned relative to the first loop so as to orient the insertion slot substantially tangentially to a longitudinal axis of the first loop and at a desired rotational position about the longitudinal axis.

4. The multi-purpose trauma shears according to claim 1, wherein the U-shaped housing is positioned relative to the first loop so as to orient the insertion slot at an angle ranging from parallel with the shearing ends with the insertion slot facing in the distal direction to perpendicular with the first gripping end with the insertion slot facing downwardly.

5. The multi-purpose trauma shears according to claim 1, wherein the U-shaped housing is positioned relative to the first loop so as to orient the insertion slot at an angle ranging from parallel with the shearing ends with the insertion slot feeing in the proximal direction to perpendicular with the first gripping end with the insertion slot facing upwardly.

6. The multi-purpose trauma, shears according to claim 1. wherein the first elongate member shearing edge and the second elongate member shearing edge are serrated or discontinuous and may be of stainless steel, high carbon steel, ceramic, titanium or other composite or coating material.

7. The multi-purpose trauma shears according to claim 1, wherein the lift lip includes a recessed band cutting edge.

8. The multi-purpose trauma shears according to claim 1, wherein the U-shaped housing is integrated into the first loop.

9. The multi-purpose trauma shears according to claim 1, wherein at least a portion of the U-shaped housing is positioned detachably on the first loop.

10. The multi-purpose trauma shears according to claim 1, wherein the at least one blade is removably mounted within the housing and wherein at least a portion of the U-shaped housing is positioned detachably on the first loop.

11. The multi-purpose trauma shears according to claim 1, wherein at least a portion of the U-shaped housing is integrated into the first loop and the U-shaped housing and first loop are longitudinally split into at least two pieces defining a loop section and a detachable section, further comprising at least one housing fastener configured to fasten the loop section and the detachable section of the U-shaped housing together in a detachable manner, and at least one member fastener configured to detachably fasten the loop section and the detachable section of the first loop together and to the first elongated member.

12. The multi-purpose trauma shears according to claim 1, wherein the U-shaped, housing is longitudinally split into two pieces, further comprising at least one housing fastener configured to fasten the two pieces together in a detachable manner, and the U-shaped housing adapted to surround a portion of the first loop so that the U-shaped housing may be positioned detachably on the first loop.

13. The multi-purpose trauma shears according to claim 1, wherein the U-shaped housing is longitudinally split into two pieces, further comprising at least one housing fastener configured to fasten the two pieces together in a detachable manner, the U-shaped housing adapted to surround a portion of the first loop so that the housing may be positioned detachably on the first loop, and
wherein the at least one blade is removably mounted within the housing and the housing is configured so as to define a compartment for storage of blades when the two pieces are fastened together.

14. The multi-purpose trauma shears, according to claim 1, wherein the first loop further comprises receiving structure defining receiving surfaces and the U-shaped, housing further comprises connecting surfaces adapted to detachably mate with the receiving surfaces so that the U-shaped housing may be positioned detachably on the first loop.

15. The multi-purpose trauma shears according to claim 1, wherein the insertion slot is open at a proximal end facing the user reducing the force required to rend fabric, seams, straps and sewn features drawing the fabric away from the patient thereby providing additional protection from further trauma.

16. The multi-purpose trauma shears according to claim 1, wherein the one or more blades comprising a straight or continuous edge at an oblique angle to the insertion slot thereby reducing the contact angle with a fabric and the amount of force required by the user to rend fabric.

17. The multi-purpose trauma shears according to claim 1, wherein the U-shaped housing comprises at least two blades wherein each blade edge is at an oblique angle to the insertion slot and facing each other.

18. The multi-purpose trauma shears according to claim 1, wherein the first loop is about 2.5 inches to about 5 inches in length and about 1.25 inches in width to about 2.5 inches and the second loop is from about 1.25 inches in diameter to about 2.5 inches in diameter,

19. The multi-purpose trauma shears according to claim 1, wherein the percussive surface is about 6 mm to about 10 mm thick for testing hypo or hyper resonance or for neurological testing.

20. The multi-purpose trauma shears according to claim 1, wherein the U-shaped housing may be constructed or coated with luminescent treatments visible in low light settings.

21. The multi-purpose trauma shears according to claim 1, wherein the second loop comprises a pivotable section further comprising the U-shaped housing with a hinge assembly on a first end and a releasable latch on a second end, the U-shaped housing rotatable from the hinge assembly in a lateral direction from the second loop.

22. Multi-purpose trauma shears, comprising:
a first elongated member with a radiused distal shearing end where the radius is about the height of the first elongated member and a proximal gripping end, wherein the shearing end has a downwardly facing shearing edge and the gripping end defines a first loop adapted to receive one or more fingers;
a second elongated member with a distal shearing end and a proximal gripping end, wherein the shearing end has a blunt distal tip and an upwardly facing shearing edge and a downwardly facing back edge, the distal shearing end defines a blunt recess proximal to the distal tip that extends beyond the downwardly facing shearing edge and a lift lip perpendicular and substantially adjacent to the second elongated member on the back edge, and the gripping end defines a second loop adapted to receive a user's thumb;
a pivot located between the shearing end arid the gripping end of the first member connecting the first member to the second member, at a corresponding point between the shearing end and the gripping end of the second member, in an adjacent, complementary, and. crossing manner so that the shearing end of the first member is capable of pivoting higher than the shearing end of the second member, the gripping end of the first member is lower than the gripping end of the second member, the shearing edge of the first member is adjacent and opposing the shearing edge of the second member, wherein opening the gripping ends relative to each other opens the shearing ends away from each other in an opposing manner and closing the gripping ends relative to each other closes the shearing ends in an adjacent manner;
the first and second elongate members angled obtusely at a corresponding point near the pivot;
a U-shaped housing having a surface defining an insertion slot having an opening at one end and at least one blade having a shearing edge recessed from the surface of the U-shaped housing and mounted within the U-shaped housing, the blade positioned within the U-shaped housing so as to present the shearing edge obliquely to the insertion slot to rend a patient's clothing material inserted into the insertion slot, a percussive surface on an outer radius substantially opposite the insertion slot; and
wherein the U-shaped housing is positioned on the second loop with the insertion slot at a desired orientation to the second loop.

23. The multi-purpose trauma shears according to claim 22, wherein the first and second, elongate members distal shearing edges are serrated providing a discontinuous edge,

24. The multi-purpose trauma shears according to claim 22, wherein the U-shaped housing is positioned relative to the second loop so as to orient the insertion slot substantially tangentially to a longitudinal axis of the second loop and at a desired rotational position around the longitudinal axis.

25. The multi-purpose trauma shears according to claim 22, wherein the U-shaped housing is positioned relative to the second loop so as to orient the insertion slot at an angle ranging from parallel with the shearing ends with the insertion slot facing in the distal direction to perpendicular with the first gripping end with the insertion slot facing downwardly.

26. The multi-purpose trauma shears according to claim 22. wherein the U-shaped housing is positioned relative to the second loop so as to orient the insertion slot at an angle ranging from parallel with the shearing ends with the insertion slot facing in the proximal direction to perpendicular with the first gripping end with the insertion slot facing upwardly.

27. The multi-purpose trauma shears according to claim 22, wherein the first elongate member shearing edge and the second elongate member shearing edge are serrated or discontinuous and may be of stainless steel, high carbon steel, ceramic, titanium or other composite or coating material.

28. The multi-purpose trauma, shears according to claim 22, wherein the clothes lifter lip includes a recessed band cutting edge.

29. The multi-purpose trauma shears according to claim 22, wherein the U-shaped housing is integrated into the second loop.

30. The multi-purpose trauma shears according to claim 22, wherein at least a portion of the U-shaped housing is positioned detachably on the second loop.

31. The multi-purpose trauma shears according to claim 22, wherein the at least one blade is removably mounted within the housing and wherein at least a portion of the U-shaped housing is positioned detachably on the second loop.

32. The multi-purpose trauma shears according to claim 22 wherein, at least a portion of the U-shaped housing is integrated into the second loop and the U-shaped housing and second loop are longitudinally split into at least two pieces defining a loop section and a detachable section, farther comprising at least one housing fastener configured to fasten the loop section and a detachable section of the U-shaped housing together, and at least one member fastener configured to detachably fasten the loop section and a detachable section of the second loop together and to the second elongated member,

33. The multi-purpose trauma shears according to claim 22, wherein the U-shaped housing is longitudinally split into two pieces, farther comprising at least one housing fastener configured to fasten the two pieces together In a detachable manner, and the U-shaped housing adapted, to surround a portion of the second loop so that the housing may be positioned detachably on the second loop.

34. The multi-purpose trauma shears according to claim 22, wherein the U-shaped housing is longitudinally split into two pieces, further comprising at least one housing fastener configured to fasten the two pieces together in a detachable manner, the U-shaped housing adapted to surround a portion of the second loop so that the housing may be positioned detachably on the second loop, and
wherein the at least one blade is removably mounted, within the housing and the housing is configured so as to define a compartment for storage of blades when the two pieces are fastened together.

35. The multi-purpose trauma shears according to claim 22, wherein the second loop further comprises receiving structure defining receiving surfaces and the U-shaped housing further comprises connecting surfaces adapted to detachably mate with the receiving surfaces so that the U-shaped housing may be positioned detachably on the second loop.

36. The multi-purpose trauma shears according to claim 22, wherein the insertion slot is open at a proximal end facing the user reducing the force required to rend fabric, seams, straps and sewn features drawing the fabric away from the patient thereby providing additional protection from further trauma.

37. The multi-purpose trauma shears according to claim 22, wherein the one or more blades comprising a straight or continuous edge at an oblique angle to the insertion slot thereby reducing the contact angle with a fabric and the amount of force required by the user to rend fabric.

38. The multi-purpose trauma shears according to claim 22, wherein the U-shaped housing comprises at least two blades wherein each blade edge is at an oblique angle to the insertion slot and facing each other.

39. The multi-purpose trauma shears according to claim 22, wherein the first loop is about 2.5 inches to about 5 inches in length and about 1.25 inches in width to about 2.5 inches and the second loop is from about 1.25 inches in diameter to about 2.5 inches in diameter.

40. The multi-purpose trauma shears according to claim 22, wherein the percussive surface is about 6 mm to about 10 mm thick for testing hypo or hyper resonance or for neurological testing.

41. The multi-purpose trauma shears according to claim 22, wherein the U-shaped housing may be constructed or coated with luminescent treatments visible in low light settings.

42. The multi-purpose trauma shears according to claim 22, wherein the second loop comprises a pivotable loop section with a pivot assembly on a first end and a releasable latch on a second end, the pivotable loop section second end rotatable from the pivot assembly in a desired direction from the second loop.

43. A multi-purpose trauma shear kit comprising:
a first elongated member with a radiused distal shearing end where the radius is about the height of the first elongated member and a proximal gripping end, wherein the shearing end has a downwardly facing shearing edge and the gripping end defines a first loop adapted to receive one or more fingers;
a second elongated member with a distal shearing end and a proximal gripping end, wherein the shearing end has a blunt distal tip and an upwardly facing shearing edge and a downwardly facing back edge, the distal shearing end defines a blunt recess proximal to the distal tip that extends beyond the downwardly facing shearing edge and a lift lip perpendicular and substantially adjacent to the second elongated member on the back edge and the gripping end defines a second loop adapted to receive a thumb;
a pivot located between the shearing end and the gripping end of the first member connecting the first member to the second member, at a corresponding point between the shearing end and the gripping end of the second member, in an adjacent, complementary, and crossing manner so that the shearing end of the first member is capable of pivoting higher than the shearing end of the second member, the gripping end of the first member is lower than the gripping end of the second member, the shearing edge of the first member is adjacent and opposing the shearing edge of the second member, wherein opening the gripping ends relative to each other opens the shearing ends away from each other in an opposing manner and closing the gripping ends relative to each other closes the shearing ends in an adjacent manner;
the first and second elongate members angles obtusely at a corresponding point near the pivot;
a U-shaped housing having a surface defining an insertion slot having an opening at one end and at least one blade having a shearing edge recessed from the surface of the U-shaped housing and removably mounted, within the U-shaped housing, the blade positioned within the U-shaped housing so as to present the shearing edge obliquely to the insertion slot to rend material inserted into the insertion slot, wherein the U-shaped housing is longitudinally split into two pieces, further comprising at least one housing fastener configured to fasten the two pieces together in a detachable manner, the U-shaped housing being adapted to surround a portion of the first loop or second loop forming a percussive surface on as outer radius substantially opposite the insertion slot and the U-shaped housing positioned detachably on the first loop or second loop, the U-shaped housing configured further to define a compartment for storage of blades;
the U-shaped housing positioned on the first loop or second loop with the insertion slot relative to the first loop or second loop so as to orient the insertion slot substantially tangentially to the first loop or second loop; and
wherein the two pieces are fastened together in a clamping fashion around the first loop or the second loop.
